(19) United States
(12) Patent Application Publication
(10) Pub. No.: US 2016/0149281 A1
(43) Pub. Date: May 26, 2016

(54) COPLANAR WAVEGUIDE STRUCTURE

(71) Applicant: METAL INDUSTRIES RESEARCH & DEVELOPMENT CENTRE, KAOHSIUNG (TW)

(72) Inventors: Cheng-Yuan HUNG, KAOHSIUNG CITY (TW); Hung-Wei WU, TAINAN CITY (TW); Yung-Wei CHEN, TAICHUNG CITY (TW); Min-Hang WENG, KAOHSIUNG CITY (TW); Yii-Der WU, KAOHSIUNG CITY (TW)

(21) Appl. No.: 14/565,399

(22) Filed: Dec. 9, 2014

(30) Foreign Application Priority Data
Nov. 25, 2014 (TW) 103140847

(51) Int. Cl. H01P 3/00

(52) U.S. Cl. CPC H01P 3/003

(57) ABSTRACT

A coplanar waveguide structure is provided, which includes a transparent substrate, a center conductor, a first ground conductor and a second ground conductor. The center conductor is disposed on the transparent substrate. The center conductor has a first light transmissive area. The first light transmissive area is greater than 80% of the area of the center conductor. The first ground conductor is disposed on the transparent substrate and opposite to a side of the center conductor. The first ground conductor has a second light transmissive area. The second light transmissive area is greater than 83% of the area of the first ground conductor. The second ground conductor is disposed on the transparent substrate and opposite to another side of the center conductor. The second ground conductor has a third light transmissive area. The third light transmissive area is greater than 83% of the area of the second ground conductor.

### RELATED APPLICATIONS

This application claims priority to Taiwan Application Serial Number 103140847, filed on Nov. 25, 2014, which is herein incorporated by reference.

### BACKGROUND

1. Field of Disclosure

The invention relates to a coplanar waveguide structure, and more particularly, to a coplanar waveguide structure with high transmittance.

2. Description of Related Art

In the field of transparent electronic elements, the first wave of technological advancement is applications for liquid crystal display (LCD) panels, touch panels and thin-film solar cells. During the first wave of technological advancement, researches to transparent conductive thin films have quite fruitful achievements. The field of transparent electronic elements now is entering the second wave of technological advancement. During the second wave of technological advancement, the most indicative representatives include next-generation electronic papers, transparent active matrix organic light emitting diode (AMOLED) panels, transparent flat panel displays and transparent solar cells. During the third wave of technological advancement in the future, electronic devices such as transparent integrated circuits, transparent non-contact small card and high definition large-size transparent displays will be the focuses for development.

For electronic devices such as next-generation electronic papers and palm-top transparent flat panel displays, if the transparency of the electronic devices are desired, the transparency of communication devices are one of the necessary requirements. However, the known transparent radio frequency passive components, such as antennas and filters, do not have transparent effect. For example, referring to FIG. 1, FIG. 1 is a schematic structural diagram of a known coplanar waveguide structure 100. The coplanar waveguide structure 100 may be used for signal transmission, which includes a substrate 110, a center conductor 120 and ground conductors 130, 140. The main feature of the coplanar waveguide structure 100 is that, the center conductor 120 used for signal transmission and the ground conductors 130, 140 disposed opposite to two opposite sides of the center conductor 120 are all located at the same surface of the substrate 110. The coplanar waveguide structure 100 has the advantages of making the serial connection and parallel connection between circuit elements easier, no need for perforation and improving selectivity of circuit layouts. However, because the transmittance of the coplanar waveguide structure 100 is close to 0, the coplanar waveguide structure 100 is not suitable for transparent electronic devices.

### SUMMARY

The objective of the invention is to provide a coplanar waveguide structure. By design of transmissive areas of the conductors on the coplanar waveguide, the transmittance of the coplanar waveguide structure can be greatly increased without affecting the frequency response. The coplanar waveguide structure of the invention applied in electronic devices can benefit transparency of the electronic devices.

One aspect of the invention is to provide a coplanar waveguide structure. The coplanar waveguide structure includes a transparent substrate, a center conductor, a first ground conductor and a second ground conductor. The center conductor is disposed on the transparent substrate and used as a signal conductor. The center conductor has at least one first light transmissive area, and the sum of the at least one first light transmissive area is greater than 80% of the area of the center conductor. The first ground conductor is disposed on the transparent substrate and located opposite to a side of the center conductor. The first ground conductor has at least one second light transmissive area, and the sum of the at least one second light transmissive area is greater than 83% of the area of the first ground conductor. The second ground conductor is disposed on the transparent substrate and located opposite to another side of the center conductor. The second ground conductor has at least one third light transmissive area, and the sum of the at least one third light transmissive area is greater than 83% of the area of the second ground conductor.

In one or more embodiments, the structure of each of the center conductor, the first ground conductor and the second ground conductor is either a ring frame structure or a mesh structure having hollow polygons.

In one or more embodiments, the structures of the center conductor, the first ground conductor and the second ground conductor are ring frame structures.

In one or more embodiments, the structures of the center conductor, the first ground conductor and the second ground conductor are mesh structures each having hollow polygons.

In one or more embodiments, the structures of the first ground conductor and the second ground conductor are the same.

In one or more embodiments, the at least one first transmissive area, the at least one second transmissive area and the at least one third transmissive area are defined by conductive lines, and each of the conductive lines has a width ranged between 1 μm and 300 μm and a thickness ranged between 0.5 μm and 500 μm.

In one or more embodiments, the conductivity of the conductive lines is greater than 10⁻⁶Ω⁻¹ m⁻¹.

In one or more embodiments, the center conductor, the first ground conductor and the second ground conductor includes aurum (Au), argentum (Ag), cuprum (Cu), aluminium (Al), stannum (Sn) or nickel (Ni).

In one or more embodiments, the center conductor, the first ground conductor and the second ground conductor include transparent conductive oxide.

In one or more embodiments, the transparent substrate is a glass substrate, a polystyrene substrate, a polyester substrate, a polycarbonate substrate, a polymethylmethacrylate substrate, a polyethylene terephthalate substrate or a transparent ceramic substrate.

Another aspect of the invention is to provide a coplanar waveguide structure. The coplanar waveguide structure includes a transparent substrate, a center conductor, a pair of coupling conductors and a pair of ground conductors. The center conductor is disposed on the transparent substrate. The center conductor has at least one first light transmissive area, and the sum of the at least one first light transmissive area is greater than 35% of the area of the center conductor. The coupling conductors are disposed on the transparent substrate and located opposite to a first side and a second side of the center conductor respectively. Each of the coupling conductors has at least one second light transmissive area. In each of the coupling conductors, the sum of the at least one second light transmissive area is greater than 60% of the area of the coupling conductor. The ground conductors are disposed on the transparent substrate and located opposite to a third side and a fourth side of the center conductor respectively. Each of the ground conductors has at least one third light transmissive area. In each of the ground conductors, the sum of the at least one third light transmissive area is greater than 50% of the area of the ground conductor.

In one or more embodiments, the structure of each of the center conductor, the coupling conductors and the ground conductors is either a ring frame structure or a mesh structure having hollow polygons.

In one or more embodiments, the structure of the center conductor is a ring frame structure.

In one or more embodiments, the structures of the coupling conductors and the ground conductors are mesh structures each having hollow polygons.

In one or more embodiments, the structures of the ground conductors are mesh structures each having hollow polygons.

In one or more embodiments, the at least one first transmissive area, the at least one second transmissive area and the at least one third transmissive area are defined by conductive lines, and each of the conductive lines has a width ranged between 1 μm and 300 μm and a thickness ranged between 0.5 μm and 500 μm.

In one or more embodiments, the conductivity of the conductive lines is greater than 10⁻⁶Ω⁻¹ m⁻¹.

In one or more embodiments, the center conductor, the coupling conductors and the ground conductors includes aurum, argentum, cuprum, aluminium, stannum or nickel.

In one or more embodiments, the center conductor, the coupling conductors and the ground conductors include transparent conductive oxide.

In one or more embodiments, the transparent substrate is a glass substrate, a polystyrene substrate, a polyester substrate, a polycarbonate substrate, a polymethylmethacrylate substrate, a polyethylene terephthalate substrate or a transparent ceramic substrate.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic structural diagram of a known coplanar waveguide structure;

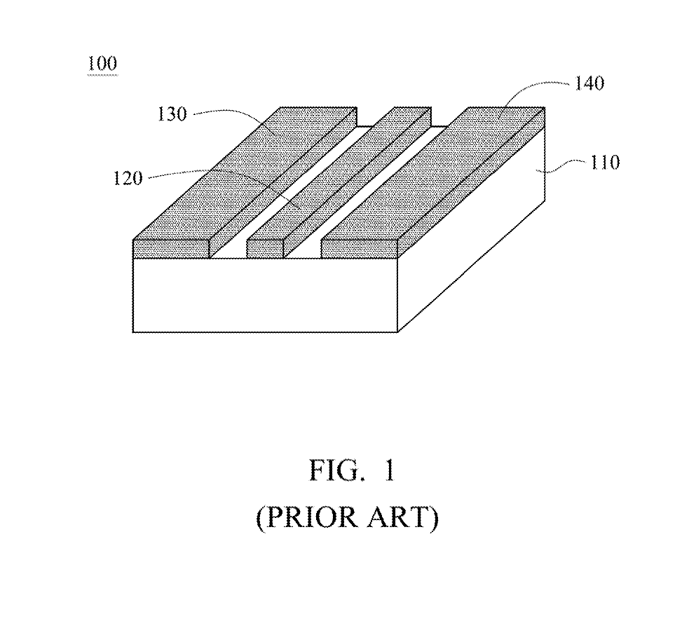

FIG. 2 is a schematic structural diagram of a coplanar waveguide structure;

FIGS. 3-5 are schematic structural diagrams of coplanar waveguide structures in accordance with some embodiments of the invention;

FIG. 6 illustrates the relationship between the frequency and the S parameter of embodiment examples of the invention and of a comparison example;

FIG. 7 is a schematic structural diagram of a coplanar waveguide structure;

FIG. 8 a schematic structural diagram of a coplanar waveguide structure in accordance with some embodiments of the invention; and

FIG. 9 illustrates the relationship between the frequency and the S parameter of an embodiment example of the invention and of a comparison example.

### DETAILED DESCRIPTION

In the following description, the disclosure will be explained with reference to embodiments thereof. However, these embodiments are not intended to limit the disclosure to any specific environment, applications or particular implementations described in these embodiments. Therefore, the description of these embodiments is only for the purpose of illustration rather than to limit the disclosure. In the following embodiments and attached drawings, elements not directly related to the disclosure are omitted from depiction; and the dimensional relationships among individual elements in the attached drawings are illustrated only for ease of understanding, but not to limit the actual scale.

It will be understood that, although the terms “first” and “second” may be used herein to describe various elements, components, regions, layers and/or sections, these elements, components, regions, layers and/or sections should not be limited by these terms. These terms are only used to distinguish one element, component, region, layer or section from another.

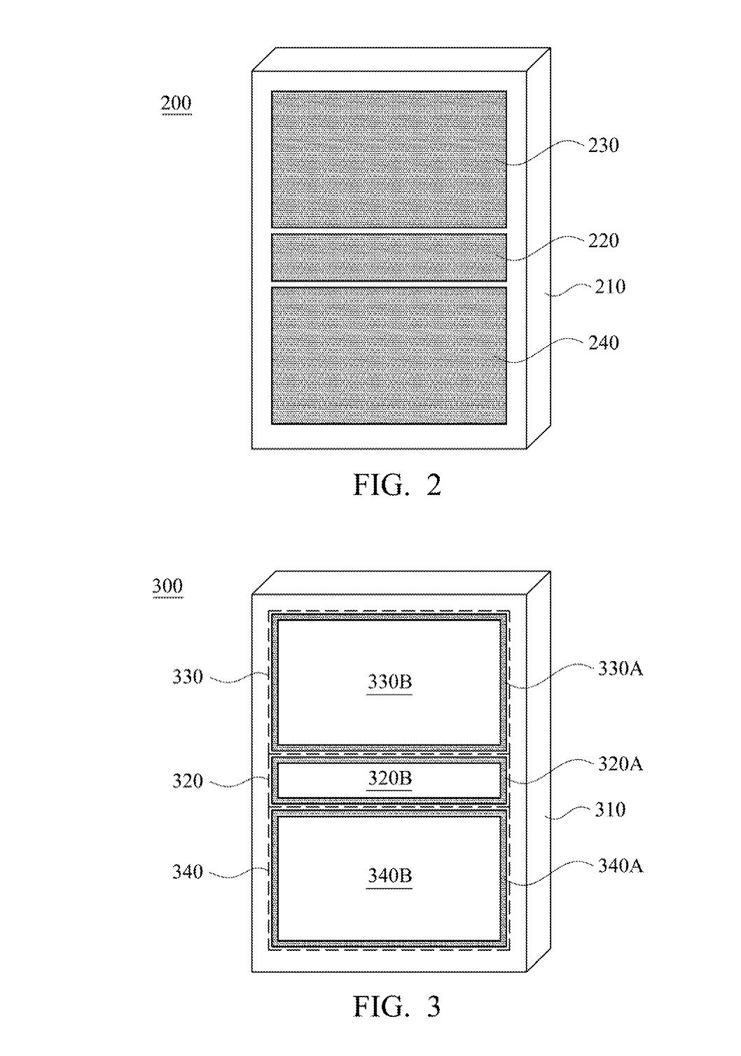

Referring to FIG. 2, FIG. 2 is a schematic structural diagram of a coplanar waveguide structure 200. The coplanar waveguide structure 200 may be used as a coplanar waveguide transmission line, which includes a transparent substrate 210, a center conductor 220 and ground conductors 230, 240. The center conductor 220 is disposed on the transparent substrate 210, and the ground conductors 230, 240 are disposed on the transparent substrate 210 and are located opposite to two opposite sides of the center conductor 220 respectively. However, the material of the center conductor 220 and the ground conductors 230, 240 is usually opaque metal, such that the transmittance of the coplanar waveguide structure 200 is close to 0, which is against transparency of electronic devices.

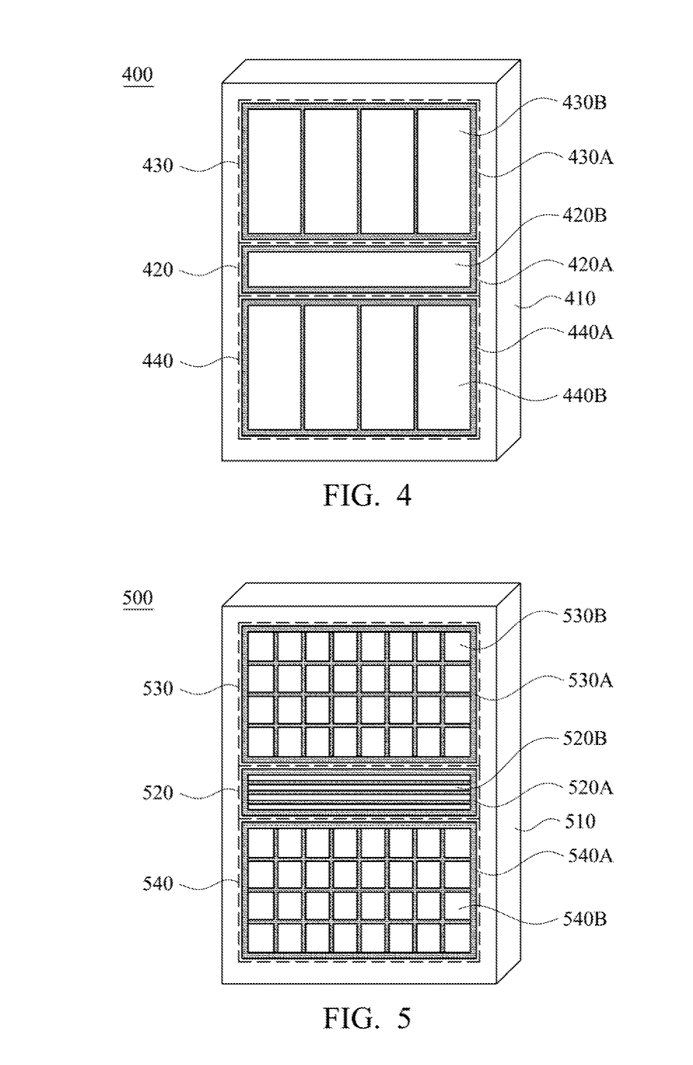

Referring to FIG. 3, FIG. 3 is a schematic structural diagram of a coplanar waveguide structure 300 in accordance with some embodiments of the invention. The coplanar waveguide structure 300 may be used as a coplanar waveguide transmission line, which includes a transparent substrate 310, a center conductor 320 and ground conductors 330, 340. The transparent substrate 310 may be a glass substrate, a polystyrene substrate, a polyester substrate, a polycarbonate substrate, a polymethylmethacrylate substrate, a polyethylene terephthalate substrate, a transparent ceramic substrate or other similar transparent substrate.

The center conductor 320 is disposed on the transparent substrate 310. The center conductor 320 is used as a signal conductor for signal transmission, which consists of conductive lines 320A and a transmissive area 320B. The conductive lines 320A form a ring frame structure, and such ring frame structure defines the transmissive area 320B. The transmissive area 320B is greater than 80% of the area of the center conductor 320, so as to improve the overall transmittance of the coplanar waveguide structure 300.

The ground conductors 330, 340 are disposed on the transparent substrate 310 and are located opposite to two opposite sides of the center conductor 320 respectively. The ground conductor 330 consists of conductive lines 330A and a transmissive area 330B, in which the conductive lines 330A form a ring frame structure, and such ring frame structure defines the transmissive area 330B. The transmissive area 330B is greater than 83% of the area of the ground conductor 330, so as to improve the overall transmittance of the coplanar waveguide structure 300. Similarly, the ground conductor 340 consists of conductive lines 340A and a transmissive area 340B, in which the conductive lines 340A form a ring frame structure, and such ring frame structure defines the transmissive area 340B. The transmissive area 340B is greater than 83% of the area of the ground conductor 340, so as to improve the overall transmittance of the coplanar waveguide structure 300. The structures of the ground conductors 330, 340 may be either the same or different.

In the coplanar waveguide structure 300, the width of the conductive lines 320A, 330A and 340A is ranged between 1 μm and 300 μm, and the thickness thereof is ranged between 0.5 μm and 500 μm. The conductive lines 320A, 330A and 340A may include aurum (Au), argentum (Ag), cuprum (Cu), aluminium (Al), stannum (Sn), nickel (Ni) or a metal alloy including the abovementioned metals, but is not limited thereto. In some embodiments, the conductive lines 320A, 330A and 340A include a transparent conductive oxide, such as indium oxide, tin oxide, zinc oxide, indium tin oxide, indium zinc oxide, fluorine-doped tin oxide, antimony-doped tin oxide, aluminum-doped zinc oxide or other similar material. Preferably, the conductivity of the conductive lines 320A, 330A and 340A is greater than 10⁻⁶Ω⁻¹ m⁻¹.

FIG. 4 is a schematic structural diagram of a coplanar waveguide structure 400 in accordance with another embodiments of the invention. The coplanar waveguide structure 400 may be used as a coplanar waveguide transmission line, which includes a transparent substrate 410, a center conductor 420 and ground conductors 430, 440. The center conductor 420 is disposed on the transparent substrate 410, and the ground conductors 430, 440 are disposed on the transparent substrate 410 and are located opposite to two opposite sides of the center conductor 420 respectively. The transparent substrate 410 may be a glass substrate, a polystyrene substrate, a polyester substrate, a polycarbonate substrate, a polymethylmethacrylate substrate, a polyethylene terephthalate substrate, a transparent ceramic substrate or other similar transparent substrate.

The center conductor 420 is used as a signal conductor for signal transmission, which consists of conductive lines 420A and a transmissive area 420B. The conductive lines 420A form a ring frame structure, and such ring frame structure defines the transmissive area 420B. The transmissive area 420B is greater than 80% of the area of the center conductor 420, so as to improve the overall transmittance of the coplanar waveguide structure 400.

The ground conductor 430 consists of conductive lines 430A and transmissive areas 430B, in which the conductive lines 430A form a mesh structure, and such mesh structure defines the transmissive areas 430B. In FIG. 4, the transmissive areas 430B includes multiple hollow rectangles, and these hollow rectangles are arranged as a matrix with one row and multiple columns. The sum of the transmissive areas 430B is greater than 83% of the area of the ground conductor 430, so as to improve the overall transmittance of the coplanar waveguide structure 400. Similarly, the ground conductor 440 consists of conductive lines 440A and transmissive areas 440B, in which the conductive lines 440A form a mesh structure, and such mesh structure defines the transmissive areas 440B. In FIG. 4, the transmissive areas 440B includes multiple hollow rectangles, and these hollow rectangles are arranged as a matrix with one row and multiple columns. The sum of the transmissive area 440B is also greater than 83% of the area of the ground conductor 440, so as to improve the overall transmittance of the coplanar waveguide structure 400. The structures of the ground conductors 430, 440 may be either the same or different.

In the coplanar waveguide structure 400, the width of the conductive lines 420A, 430A and 440A is ranged between 1 μm and 300 μm, and the thickness thereof is ranged between 0.5 μm and 500 μm. The conductive lines 420A, 430A and 440A may have different widths and/or thickness. The conductive lines 420A, 430A and 440A may include aurum, argentum, cuprum, aluminium, stannum, nickel or a metal alloy including the abovementioned metals, but is not limited thereto. In some embodiments, the conductive lines 420A, 430A and 440A include a transparent conductive oxide, such as indium oxide, tin oxide, zinc oxide, indium tin oxide, indium zinc oxide, fluorine-doped tin oxide, antimony-doped tin oxide, aluminum-doped zinc oxide or other similar material. Preferably, the conductivity of the conductive lines 420A, 430A and 440A is greater than 10⁻⁶Ω⁻¹ m⁻¹.

FIG. 5 is a schematic structural diagram of a coplanar waveguide structure 500 in accordance with another embodiments of the invention. The coplanar waveguide structure 500 may be used as a coplanar waveguide transmission line, which includes a transparent substrate 510, a center conductor 520 and ground conductors 530, 540. The center conductor 520 is disposed on the transparent substrate 510, and the ground conductors 530, 540 are disposed on the transparent substrate 510 and are located opposite to two opposite sides of the center conductor 520 respectively. The transparent substrate 510 may be a glass substrate, a polystyrene substrate, a polyester substrate, a polycarbonate substrate, a polymethylmethacrylate substrate, a polyethylene terephthalate substrate, a transparent ceramic substrate or other similar transparent substrate.

The center conductor 520 is used as a signal conductor for signal transmission, which consists of conductive lines 520A and transmissive areas 520B. The conductive lines 520A form a mesh structure, and such mesh structure defines the transmissive areas 520B. In FIG. 5, the transmissive areas 520B includes multiple hollow rectangles, and these hollow rectangles are arranged as a matrix with multiple rows and one column. The sum of the transmissive areas 520B is greater than 80% of the area of the center conductor 520, so as to improve the overall transmittance of the coplanar waveguide structure 500.

The ground conductor 530 consists of conductive lines 530A and transmissive areas 530B, in which the conductive lines 530A form a mesh structure, and such mesh structure defines the transmissive areas 530B. In FIG. 5, the transmissive areas 530B includes multiple hollow rectangles, and these hollow rectangles are arranged as a matrix with multiple rows and multiple columns. The sum of the transmissive areas 530B is greater than 83% of the area of the ground conductor 530, so as to improve the overall transmittance of the coplanar waveguide structure 500. Similarly, the ground conductor 540 consists of conductive lines 540A and transmissive areas 540B, in which the conductive lines 540A form a mesh structure, and such mesh structure defines the transmissive areas 540B. In FIG. 5, the transmissive areas 540B includes multiple hollow rectangles, and these hollow rectangles are arranged as a matrix with multiple rows and multiple columns. The sum of the transmissive area 540B is also greater than 83% of the area of the ground conductor 540, so as to improve the overall transmittance of the coplanar waveguide structure 500. The structures of the ground conductors 530, 540 may be either the same or different.

In the coplanar waveguide structure 500, the width of the conductive lines 520A, 530A and 540A is ranged between 1 μm and 300 μm, and the thickness thereof is ranged between 0.5 μm and 500 μm. The conductive lines 520A, 530A and 540A may have different widths and/or thickness. The conductive lines 520A, 530A and 540A may include aurum, argentum, cuprum, aluminium, stannum, nickel or a metal alloy including the abovementioned metals, but is not limited thereto. In some embodiments, the conductive lines 520A, 530A and 540A include a transparent conductive oxide, such as indium oxide, tin oxide, zinc oxide, indium tin oxide, indium zinc oxide, fluorine-doped tin oxide, antimony-doped tin oxide, aluminum-doped zinc oxide or other similar material. Preferably, the conductivity of the conductive lines 520A, 530A and 540A is greater than 10⁻⁶Ω⁻¹ m⁻¹.

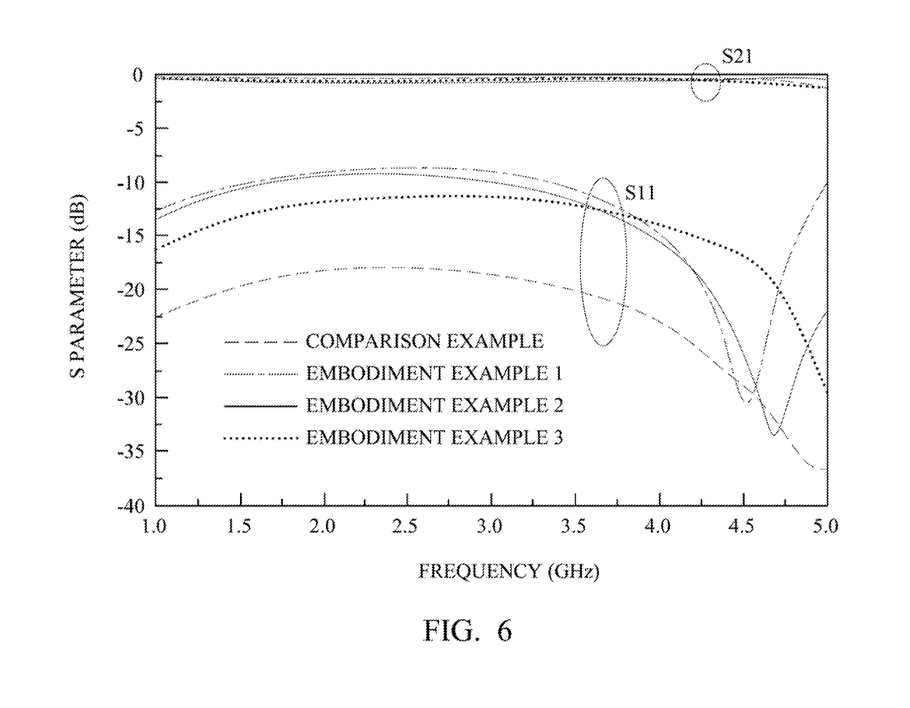

FIG. 6 illustrates the relationship between the frequency and the S parameter of embodiment examples of the invention and of a comparison example. In FIG. 6, the coplanar waveguide structure 200 is used as Comparison Example; the coplanar waveguide structure 300 is used as Embodiment Example 1, and the overall transmittance of the coplanar waveguide structure 300 is 85%; the coplanar waveguide structure 400 is used as Embodiment Example 2, and the overall transmittance of the coplanar waveguide structure 400 is 82%; the coplanar waveguide structure 500 is used as Embodiment Example 3, and the overall transmittance of the coplanar waveguide structure 500 is 91%. In Embodiment Examples 1-3, the transparent substrates are FR4 substrates with the dielectric constant of 4.4 Fm⁻¹, the width of the conductive lines is 300 μm, the widths of the center conductors are all 4 mm, and the gaps between any ground conductor and the center conductors are all 0.3 mm, such that the characteristic impedance of the coplanar waveguide structures are 50Ω. Likewise, in Comparison Example, the transparent substrate is a FR4 substrate with the dielectric constant of 4.4 Fm⁻¹, the width of the center conductors is 4 mm, and the gap between any ground conductor and the center conductor is 0.3 mm, such that the characteristic impedance of the coplanar waveguide structure is 50Ω.

As can be seen from FIG. 6, at the frequency of 1-4.7 GHz of the transmission signal, the differences between the return losses S11 of Embodiment Examples 1-3 and the return loss S11 of Comparison Example are all less than 10 dB. Furthermore, at the specific frequency, the return loss S11 of Embodiment Examples 1 or Embodiment Example 2 can be lower than the return loss S11 of Comparison Example (For example, at the frequency of about 4.5 GHz of the transmission signal, the return losses S11 of Embodiment Example 1 is lower than the return loss S11 of Comparison Example). On the other hand, the insertion losses S21 of Embodiment Examples 1-3 are all at the range of −0.5 dB and 0 dB, and the differences between the insertion losses S21 of Embodiment Examples 1-3 and the insertion loss S21 of Comparison Example are all less than 0.5 dB.

As can be seen from above, the coplanar waveguide structures 300, 400 and 500 used as coplanar waveguide transmission lines include high transmittance and can keep suitable frequency response for signal transmission. Therefore, the coplanar waveguide structures 300, 400 or 500 applied in electronic devices can benefit transparency of the electronic devices.

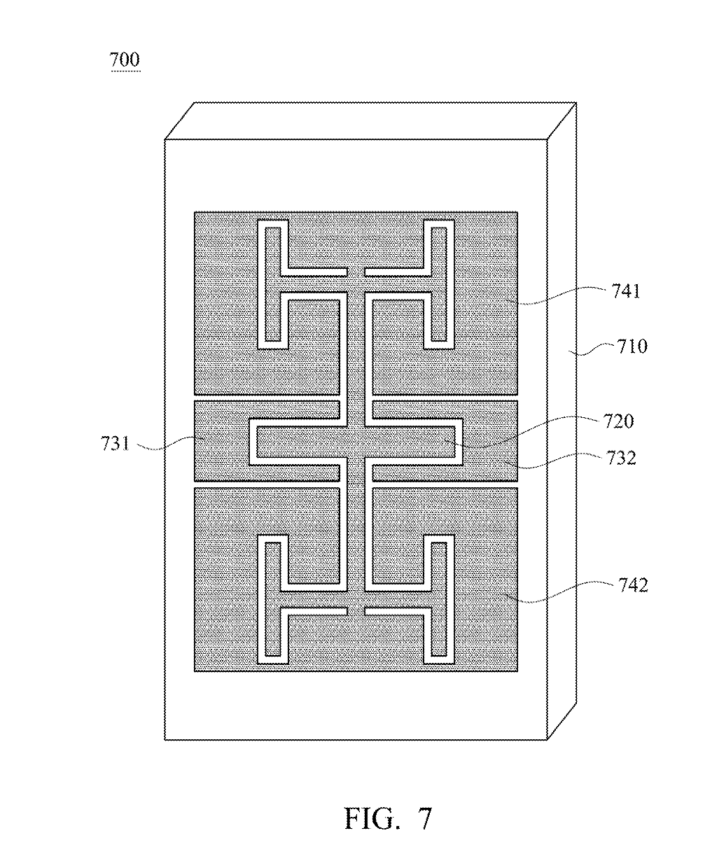

Referring to FIG. 7, FIG. 7 is a schematic structural diagram of a coplanar waveguide structure 700. The coplanar waveguide structure 700 may be used as a coplanar waveguide filter, which includes a transparent substrate 710, a center conductor 720, coupling conductors 731, 732 and ground conductors 741, 742. The center conductor 720 is disposed on the transparent substrate 710, the coupling conductors 731, 732 are disposed on the transparent substrate 710 and are located opposite to the left and right sides of the center conductor 720 respectively, and the ground conductors 741, 742 are disposed on the transparent substrate 710 and are located opposite to the upper and lower sides of the center conductor 720 respectively. However, the material of the center conductor 720, the coupling conductors 731, 732 and the ground conductors 741, 742 is usually opaque metal, such that the transmittance of the coplanar waveguide structure 700 is close to 0, which is against transparency of electronic devices.

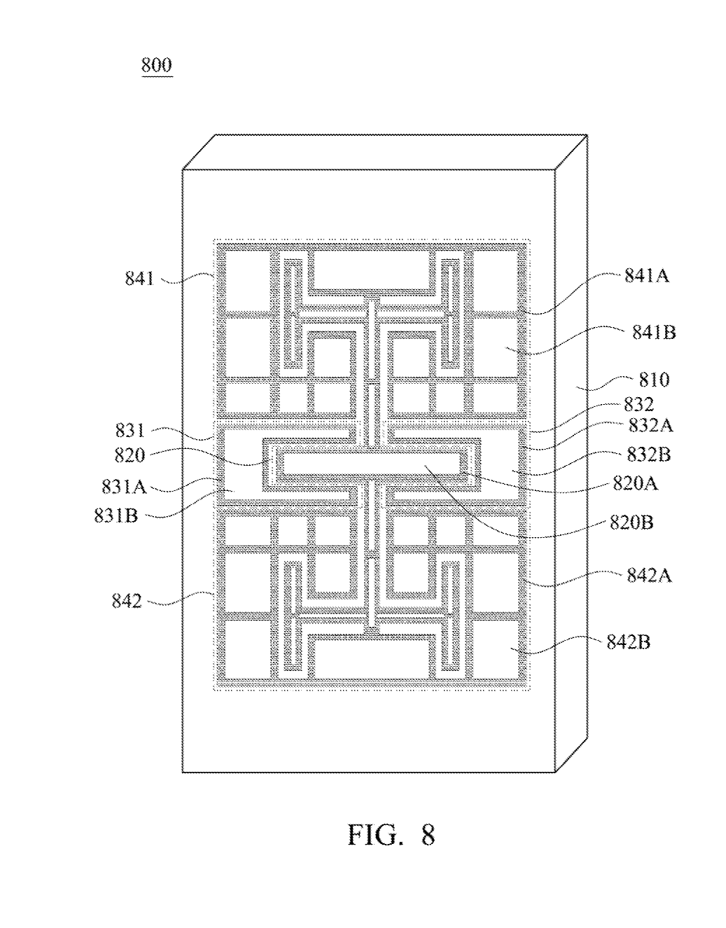

Referring to FIG. 8, FIG. 8 is a schematic structural diagram of a coplanar waveguide structure 800 in accordance with some embodiments of the invention. The coplanar waveguide structure 800 may be used as a coplanar waveguide filter, which includes a transparent substrate 810, a center conductor 820, coupling conductors 831, 832 and ground conductors 841, 842. The transparent substrate 810 may be a glass substrate, a polystyrene substrate, a polyester substrate, a polycarbonate substrate, a polymethylmethacrylate substrate, a polyethylene terephthalate substrate, a transparent ceramic substrate or other similar transparent substrate.

The center conductor 820 is disposed on the transparent substrate 810. The center conductor 820 is used as a conductor for filter response resonance, which consists of conductive lines 820A and a transmissive area 820B. The conductive lines 820A form a ring frame structure, and such ring frame structure defines the transmissive area 820B. The transmissive area 820B is greater than 35% of the area of the center conductor 820, so as to improve the overall transmittance of the coplanar waveguide structure 800.

The coupling conductors 831, 832 are disposed on the transparent substrate 810 and are used as conductors for signal coupling transmission. The coupling conductors 831, 832 are located opposite to the left and right sides of the center conductor 820 respectively, and both are physically separated from the center conductor 820. The coupling conductor 831 consists of conductive lines 831A and a transmissive area 831B, and the coupling conductor 832 consists of conductive lines 832A and a transmissive area 832B. The conductive lines 831A, 832A form ring frame structures, and these ring frame structures define the transmissive areas 831B, 832B respectively. The transmissive areas 831B, 832B are greater than 60% of the area of the coupling conductors 831, 832, respectively, so as to improve the overall transmittance of the coplanar waveguide structure 800.

The ground conductors 841, 842 are disposed on the transparent substrate 810. The ground conductors 841, 842 are located opposite to the upper and lower sides of the center conductor 820 respectively. The ground conductor 841 consists of conductive lines 841A and transmissive areas 841B, and the ground conductor 842 consists of conductive lines 842A and transmissive areas 842B. The conductive lines 841A, 842A form mesh structures, and these mesh structures define the transmissive areas 841B, 842B respectively. In FIG. 8, the transmissive areas 841B, 842B include multiple hollow rectangles. The sums of the transmissive areas 841B, 842B are greater than 50% of the area of the ground conductors 841, 842, respectively, so as to improve the overall transmittance of the coplanar waveguide structure 800.

In the coplanar waveguide structure 800, the width of the conductive lines 820A, 831A, 832A, 841A and 842A is ranged between 1 μm and 300 μm, and the thickness thereof is ranged between 0.5 μm and 500 μm. The conductive lines 820A, 831A, 832A, 841A and 842A may include aurum, argentum, cuprum, aluminium, stannum, nickel or a metal alloy including the abovementioned metals, but is not limited thereto. In some embodiments, the conductive lines 820A, 831A, 832A, 841A and 842A include a transparent conductive oxide, such as indium oxide, tin oxide, zinc oxide, indium tin oxide, indium zinc oxide, fluorine-doped tin oxide, antimony-doped tin oxide, aluminum-doped zinc oxide or other similar material. Preferably, the conductivity of the conductive lines 820A, 831A, 832A, 841A and 842A is greater than 10⁻⁶Ω⁻¹ m⁻¹.

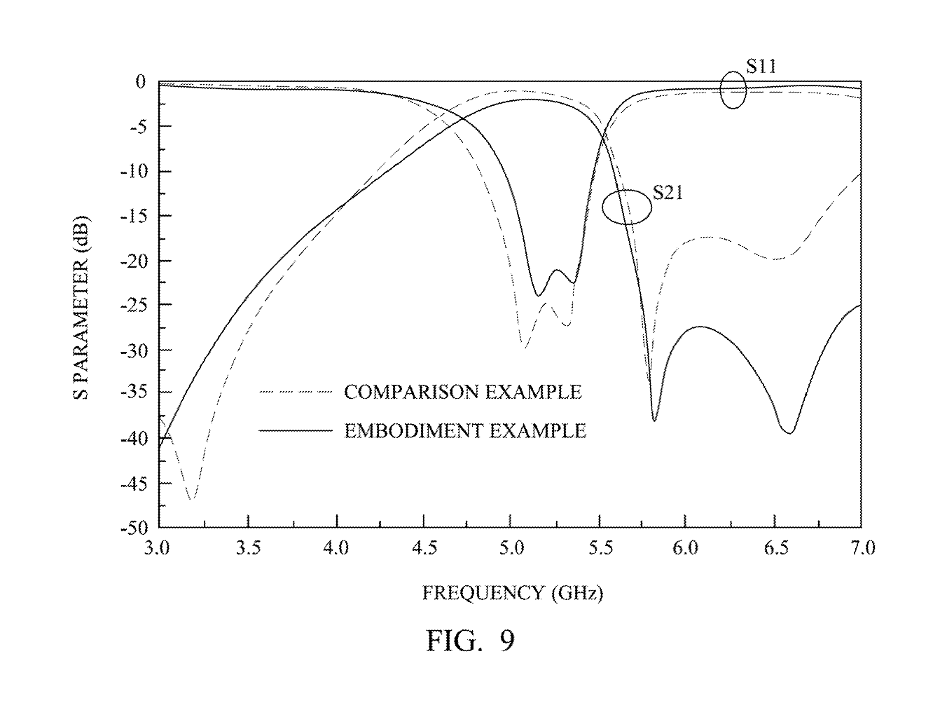

FIG. 9 illustrates the relationship between the frequency and the S parameter of an embodiment example of the invention and of a comparison example. In FIG. 9, the coplanar waveguide structure 700 is used as Comparison Example; the coplanar waveguide structure 800 is used as Embodiment Example, and the overall transmittance of the coplanar waveguide structure 800 is 50%. In Embodiment Example, the transparent substrates are FR4 substrates with the dielectric constant of 4.4 Fm⁻¹, the width of the conductive lines is 300 μm, and the gaps between any ground conductor and the center conductors are all 0.3 mm. Likewise, in Comparison Example, the transparent substrate is a FR4 substrate with the dielectric constant of 4.4 Fm⁻¹, and the gap between any ground conductor and the center conductor is 0.3 mm. The center frequencies of Embodiment Example and Comparison Example are all 5.2 GHz.

As can be seen from FIG. 9, the band-pass frequency ranges of Embodiment Example and Comparison Example are all 4.6-5.5 GHz. At the band-pass frequency range of 4.6-5.5 GHz, the differences between the return loss S11 of Embodiment Example and the return loss S11 of Comparison Example is less than 10 dB, and the lowest value of the return loss S11 of Embodiment Example can be lower than −20 dB. On the other hand, the difference between the insertion loss S21 of Embodiment Example and the insertion loss S21 of Comparison Example is less than 0.5 dB, and the insertion losses S21 of Embodiment Example is at the range between −2 dB and 0 dB.

As can be seen from above, the coplanar waveguide structure 800 used as a coplanar waveguide filter includes high transmittance and can keep suitable frequency response suitable for signal transmission. Therefore, the coplanar waveguide structure 800 applied in electronic devices can benefit transparency of the electronic devices.

Here, it should be emphasized that, the spirit of the invention is to design the conductors of the coplanar waveguide structure to have transmissive areas, so as to effectively increase the transmittance of the coplanar waveguide structure. Such coplanar waveguide structure can be applied to electronic device for improving the transparency of the electronic devices. The coplanar waveguide structures 400, 500, 800 of FIGS. 4-5, 8 are merely illustrative examples of the invention, but are not meant to limit the scope of the invention. For example, the transmissive areas 520B, 530B and 540B illustrated in FIG. 5 may be modified to have multiple hollow polygons with different shapes.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims.

What is claimed is:

1. A coplanar waveguide structure, comprising:
a transparent substrate;
a center conductor disposed on the transparent substrate and used as a signal conductor, wherein the center conductor has at least one first light transmissive area, the sum of the at least one first light transmissive area greater than 80% of the area of the center conductor;
a first ground conductor disposed on the transparent substrate and located opposite to a side of the center conductor, wherein the first ground conductor has at least one second light transmissive area, the sum of the at least one second light transmissive area greater than 83% of the area of the first ground conductor; and
a second ground conductor disposed on the transparent substrate and located opposite to another side of the center conductor, wherein the second ground conductor has at least one third light transmissive area, the sum of the at least one third light transmissive area greater than 83% of the area of the second ground conductor.

2. The coplanar waveguide structure of claim 1, wherein the structure of each of the center conductor, the first ground conductor and the second ground conductor is either a ring frame structure or a mesh structure having a plurality of hollow polygons.

3. The coplanar waveguide structure of claim 1, wherein the structures of the center conductor, the first ground conductor and the second ground conductor are ring frame structures.

4. The coplanar waveguide structure of claim 1, wherein the structures of the center conductor, the first ground conductor and the second ground conductor are mesh structures each having a plurality of hollow polygons.

5. The coplanar waveguide structure of claim 1, wherein the structures of the first ground conductor and the second ground conductor are the same.

6. The coplanar waveguide structure of claim 1, wherein the at least one first transmissive area, the at least one second transmissive area and the at least one third transmissive area are defined by a plurality of conductive lines, each of the conductive lines having a width ranged between 1 μm and 300 μm and a thickness ranged between 0.5 μm and 500 μm.

7. The coplanar waveguide structure of claim 6, wherein the conductivity of the conductive lines is greater than 10⁻⁶Ω⁻¹ m⁻¹.

8. The coplanar waveguide structure of claim 1, wherein the center conductor, the first ground conductor and the second ground conductor comprise at least one material selected from the group consisting of aurum (Au), argentum (Ag), cuprum (Cu), aluminium (Al), stannum (Sn) and nickel (Ni).

9. The coplanar waveguide structure of claim 1, wherein the center conductor, the first ground conductor and the second ground conductor comprise transparent conductive oxide.

10. The coplanar waveguide structure of claim 1, wherein the transparent substrate is a glass substrate, a polystyrene substrate, a polyester substrate, a polycarbonate substrate, a polymethylmethacrylate substrate, a polyethylene terephthalate substrate or a transparent ceramic substrate.

11. A coplanar waveguide structure, comprising:
a transparent substrate;
a center conductor disposed on the transparent substrate, wherein the center conductor has at least one first light transmissive area, the sum of the at least one first light transmissive area greater than 35% of the area of the center conductor;
a pair of coupling conductors disposed on the transparent substrate and located opposite to a first side and a second side of the center conductor respectively, wherein each of the coupling conductors has at least one second light transmissive area, the sum of the at least one second light transmissive area greater than 60% of the area of the coupling conductor; and
a pair of ground conductors disposed on the transparent substrate and located opposite to a third side and a fourth side of the center conductor respectively, wherein each of the ground conductors has at least one third light transmissive area, the sum of the at least one third light transmissive area greater than 50% of the area of the ground conductor.

12. The coplanar waveguide structure of claim 11, wherein the structure of each of the center conductor, the coupling conductors and the ground conductors is either a ring frame structure or a mesh structure having a plurality of hollow polygons.

13. The coplanar waveguide structure of claim 11, wherein the structure of the center conductor is a ring frame structure.

14. The coplanar waveguide structure of claim 11, wherein the structures of the coupling conductors and the ground conductors are mesh structures each having a plurality of hollow polygons.

15. The coplanar waveguide structure of claim 11, wherein the structures of the ground conductors are mesh structures each having a plurality of hollow polygons.

16. The coplanar waveguide structure of claim 11, wherein the at least one first transmissive area, the at least one second transmissive area and the at least one third transmissive area are defined by a plurality of conductive lines, each of the conductive lines having a width ranged between 1 μm and 300 μm and a thickness ranged between 0.5 μm and 500 μm.

17. The coplanar waveguide structure of claim 16, wherein the conductivity of the conductive lines is greater than 10⁻⁶Ω⁻¹ m⁻¹.

18. The coplanar waveguide structure of claim 11, wherein the center conductor, the coupling conductors and the ground conductors comprise at least one material selected from the group consisting of aurum, argentum, cuprum, aluminium, stannum and nickel.

19. The coplanar waveguide structure of claim 11, wherein the center conductor, the coupling conductors and the ground conductors comprise transparent conductive oxide.

20. The coplanar waveguide structure of claim 11, wherein the transparent substrate is a glass substrate, a polystyrene substrate, a polyester substrate, a polycarbonate substrate, a polymethylmethacrylate substrate, a polyethylene terephthalate substrate or a transparent ceramic substrate.
